(19) United States
(12) Patent Application Publication
(10) Pub. No.: US 2011/0174805 A1
(43) Pub. Date: Jul. 21, 2011

(54) WEAVING TORCH DEVICE FOR AUTO WELDING

(75) Inventor: Young Jae Jung, Ulsan (KR)

(73) Assignee: SM T & D Co., Ltd., Buk-gu Ulsan (KR)

(21) Appl. No.: 13/121,564

(22) PCT Filed: Nov. 6, 2008
(86) PCT No.: PCT/KR2008/006523

§ 371 Date: Mar. 29, 2011

(30) Foreign Application Priority Data
Sep. 30, 2008 (KR) 10-2008-0096139
Oct. 28, 2008 (KR) 20-2008-0014371

(51) Int. Cl. B23K 13/01

(52) U.S. Cl. 219/617

(57) ABSTRACT

The present invention relates a weaving torch device for auto welding that can maintain necessary molten metal for desired welding such as welding by a person and provide the best welding beads, by locking a hinge pin and a conveying pin, which are provided to both sides of a weaving torch of a torch device connected to a welding machine, to a locking protrusion and a locking step of a hinge support member of a lower case in order to prevent left/right conveying while the weaving torch is automatically reciprocated up/down by operation of an electromagnet and a conveying spring.

### TECHNICAL FIELD

The present invention relates to a weaving torch device for auto welding, more particularly a weaving torch device for auto welding that can maintain necessary molten metal for desired welding such as welding by a person and provide the best welding beads, by locking a hinge pin and a conveying pin, which are provided to both sides of a weaving torch of a torch device connected to a welding machine, to a locking protrusion and a locking step of a hinge support member of a lower case in order to prevent left/right conveying while the weaving torch is automatically reciprocated up/down by the operation of an electromagnet and a conveying spring.

### BACKGROUND ART

In general, welding processes that are performed under working conditions, such as at a ship-building yard, are generally divided into manual welding that is performed by a person and auto welding that is performed automatically, in which an auto carriage welding process is primarily used for the auto welding.

A manual welding torch is generally used for the auto carriage welding process.

However, using the manual weaving torch for the auto carriage welding caused problems, such as creating many defects in the welding beads.

On the other hand, weaving torches using an electromagnet have been used in recent years. However, weaving torches that have been used in the related art had a problem in that since an electromagnet is disposed at the upper portion of a welding tip, spatters, smoke, flame, and the remains that are generated during welding flow back into a case where a welding torch is inserted, such that it causes a defect in the electromagnet while decreasing the life span of the weaving torch.

Further, the weaving torch with the electromagnet at the upper portion of the welding tip in the related art had a problem in that the electromagnet is close to the arc, such that the electromagnet is heated by the arc heat during welding. Therefore, it is difficult to maintain welding quality because of change in weaving pattern due to decrease of the magnetic force of the electromagnet in long-time welding.

Further, the weaving torch in the related art had a critical problem in that the work efficiency of the welding speed is decreased to 500 mm/min by the amount of welding beads and spatters, and various internal defects during welding, and it is required to restart the welding if, in a welding process of a ship, the welding is of poor quality.

[Table] Shaft Stroke Length and Shaft Stroke Strength of Electromagnet

On the other hand, the above table shows shaft stroke strength to shaft stroke length of an electromagnet and it can be seen from the table that a shaft is stroked at a high stroke strength of 180 to 250N at 1 mm stroke length of the electromagnet, whereas the stroke strength of the shaft considerably drops to 40N above a stroke length of 3 mm.

Therefore, it is preferable to maintain an appropriate stroke length of the shaft of the electromagnet so that the electromagnet weaves the weaving torch at an appropriate stroke strength during welding; however, the weaving torches in the related art had a problem in that it is impossible to appropriately adjust the stroke length of the shaft of the electromagnet.

Further, the weaving torches in the related art had a problem in that a welding cable with one side connected to a welding machine and the other side connected to the rear end of the weaving torch bends or affects the up-down weaving width of the weaving torch due to external shock during a welding process, such that arc becomes unstable, weldability decreases, and defects are made in the welding beads.

Furthermore, the weaving torches in the related art had a problem in that a welding process should be restarted when, during a welding process of a ship, etc., the welding is of poor quality due to the amount of welding beads and spatters and a variety of internal defects during welding.

### DISCLOSURE OF INVENTION

### Technical Problem

In order to overcome the above problems, it is an object of the present invention to provide a weaving torch device for auto welding that can maintain necessary molten metal for desired welding, such as welding by a person and provide the best welding beads, by locking a hinge pin and a conveying pin, which are provided to both sides of a weaving torch of a torch device connected to a welding machine, to a locking protrusion and a locking step of a hinge support member of a lower case in order to prevent left/right conveying while the weaving torch is automatically reciprocated up/down by the operation of an electromagnet and a conveying spring.

Further, it is another object of the present invention to provide a weaving torch device for auto welding that can prevent internal defects of the weaving torch by preventing backward flow of spatters, smoke, flame etc., which are created during welding, into the lower case and the upper case, and also extend the life of an electromagnet and increase the welding speed to the maximum while increasing work efficiency and productivity, by using a backward flow prevention film that is provided in a welding tip connected to the front end of a torch body of a weaving torch and of which the lower portion and the upper portion are disposed in the front end portion of a lower case and an upper case.

Further, it is another object of the invention to provide a weaving torch device for auto welding that can maintain desired quality of welding beads and welding by automatically weaving the weaving torch using the electromagnet and a conveying spring, and can considerably decrease the amount of spatters and improve the work conditions and safety during welding.

Further, it is another object of the invention to provide a weaving torch device for auto welding that can fix a welding cable to provide the best quality welding beads by preventing influence on the welding quality due to changes in the up-down weaving width of the torch when the welding cable connected to the rear end of the weaving torch is moved by an external shock, because the welding cable is fixed to the inner surfaces of the rear end portion of the lower case and the upper case.

Further, it is another object of the invention to provide a weaving torch device for auto welding that can easily supply a welding wire and carbon dioxide into a gas cable by press-fitting a fixing ring, which is fixed on the inner surfaces of the rear end portions of the lower case and the upper case, on the outer surface of an insulated cable of the welding cable, and providing a support ring that supports the fixing ring such that the gas cable is not compressed by the fixing ring press-fitted on the outer surface of the insulated cable.

Further, it is another object of the invention to provide a weaving torch device for auto welding that can prevent influence on the weaving of the weaving torch, even if external pressure or an external shock is applied to the welding cable, by forming fixing grooves, which fix the upper portion and the lower portion of the fixing ring that is press-fitted on the outer surface of the insulated cable of the welding cable, on the inner surfaces of the rear end portions of the lower case and the upper case, and providing a plurality of movement prevention protrusions on the inner surfaces of the fixing grooves to fix the fixing ring while closely contacting with the outer surface of the fixing ring.

### Technical Solution

In order to achieve the objects, a weaving torch apparatus for auto welding, according to the present invention includes: a lower case 100 that has a lower body 110 formed in a long semicircular shape; an upper case 200 that has an upper body 210 formed in long semicircular shape and is connected to the upper portion of the lower case 100; a weaving torch 300 that has a torch body 310 having a wire insertion hole 330 at the center portion, where a welding wire 320 is inserted, and is disposed inside the lower case 100 and the upper case 200 while transmitting welding electric current of a welding machine to a welding tip 340, in which a welding tip 340 is connected to the front end of the torch body 310, a welding cable 350 through which outside power is supplied is connected to the rear end of the torch body 310; an electromagnet 400 that is connected to the upper center portion of the upper body 210 of the upper case 200 and conveys the torch body 310 of the weaving torch 300 downward; a backward flow prevention film 500 that has a through-hole at the center and is disposed at the front end portions inside the lower body 110 of the lower case 100 and the upper body 210 of the upper case 200 while being connected to the welding tip 340 connected to the front end of the torch body 310 of the weaving torch 300; and a conveying spring 600 that conveys the torch body 310 upward using elasticity while the lower portion thereof is supported by the upper portion of the lower body 110 of the lower case 100 and the upper portion supports the lower portion of the torch body 310 of the weaving torch 300.

The lower case 100 has: fitting grooves 120 that are formed at both inner sides of the front end portion of a lower body 110; hinge support members 130 that have locking protrusions 131 protruding upward at both sides and a hinge groove 132 between the locking protrusions 131 to be fitted in the fitting grooves 120; locking steps 140 protruding upward and provided at both sides of the center portion of the lower body 110; a conveying groove 150 is provided at the center portion in the locking step 140; a spring-fixing protrusion 160 protruding upward and provided at the center portion on the bottom of the lower body 110; a first prevention film insertion groove 170 in which the lower portion of a backward flow prevention film 500 is inserted and which is formed along the inner surface of the front end portion of the lower body 110; and a first up-down conveying-fixing step 180 protruding upward in a semicircular shape and provided behind the first prevention film insertion groove 170.

Further, the upper case 200 has: a support member insertion grooves 220 formed at both inner sides of the front end portion of an upper body having a long semicircular shape to insert the locking protrusions 131 of the hinge support member 130 of the lower case 100; locking-step insertion grooves 230 provided at the lower portions of both inner sides at the center portion of the upper body 210 and connected to the upper portion of the lower case 100 to insert the locking steps 140 of the lower case 100; a semicircular second prevention film insertion groove 240 formed on the inner surface of the front end portion of the upper body 210 to insert the upper portion of the backward flow prevention film 500; and a second up-down conveying-fixing step 250 protruding downward in a semicircular shape, behind the second prevention film insertion groove 240.

The weaving torch 300 has: a wire insertion hole 330 formed through the center portion of a torch body 310 to insert a welding wire 320; a welding tip 340 connected to the front end of the torch body 310; a welding cable 350 connected to the rear end of the torch body 310 to supply outside power; hinge protrusions 360 protruding outside on both sides at the front portion of the torch body 310; hinge pins 370 protruding outside in a smaller size than the hinge protrusion 360 on the outer surface of the hinge protrusion 360 to be fitted in the hinge groove 132 of the hinge support member 130 of the lower case 100; conveying protrusions 380 protruding outside on both sides at the center portion of the torch body 310; conveying pins 390 provided on the outer surface of the conveying protrusions 380 to be fitted in the conveying grooves 150 of the lower case 100; and a hinge-fixing spring 610 of which the lower end is supported by the upper portion of the torch body 310 and the upper portion thereof is supported by the lower portion of upper body 210 of the upper case 200 to fix the hinge pin 370 such that the hinge pin 370 does not move upward.

The electromagnet 400 has: a detachable conveying plate 420, which is attached/detached to the upper portion of an electromagnet body 410 and conveyed up/down by power that is supplied from the outside, at the upper portion of the electromagnet body 410; an electromagnetic shaft 430 connected to the central lower portion of the detachable conveying plate 420 and conveyed down with the detachable conveying plate 420 through the center of the electromagnet body 410 and the upper body 210 of the upper case 200; an insulating cap 440 connected to the lower end of the electromagnetic shaft 430 to insulate the electromagnet shaft 430 from the torch body 310 of the weaving torch 300; an up-down conveying-adjusting member 450 making it possible to adjust up-down conveying distance of the detachable conveying plate 420 and the electromagnetic shaft 430 while being conveyed up/down; and an electromagnet protection case 460 having a threaded-hole at the upper center portion and in which the electromagnet body 410 of the electromagnet 400 is inserted such that the electromagnet body 410 is not exposed outside, and fixed to the upper portion of the upper body 210 of the upper case 200 by fixing-bolts 480 to discharge the heat, which is generated from the electromagnet body 410 of the electromagnet 400, to the outside.

Further, a weaving torch apparatus for auto welding according to the present invention includes: a lower case 100 that has a lower body 110 formed in a long semicircular shape; an upper case 200 that has an upper body 210 formed in long semicircular shape and is connected to the upper portion of the lower case 100; a weaving torch 300 that has a torch body 310 having a wire insertion hole 330 at the center portion, where a welding wire 320 is inserted, and is disposed inside the lower case 100 and the upper case 200 while transmitting welding electric current from a welding machine to a welding tip 340, in which a welding tip 340 is connected to the front end of the torch body 310, a welding cable 350 through which outside power is supplied is connected to the rear end of the torch body 310; an electromagnet 400 that is connected to the upper center portion of the upper body 210 of the upper case 200 and conveys downward the torch body 310 of the weaving torch 300; a backward flow prevention film 500 that has a through-hole at the center and is disposed at the front end portions inside the lower body 110 of the lower case 100 and the upper body 210 of the upper case 200 while being connected to the welding tip 340 connected to the front end of the torch body 310 of the weaving torch 300; a conveying spring 600 that conveys upward the torch body 310 using elasticity while the lower portion thereof is supported by the upper portion of the lower body 110 of the lower case 100 and the upper portion supports the lower portion of the torch body 310 of the weaving torch 300; s fixing ring 700 fitted on the outer surface of an insulated cable 220 of the welding cable 200; and a support ring 800 supporting the fixing ring 700 in a gas cable 210 of the welding cable 200.

The lower case 100 has: fitting grooves 120 that are formed at both inner sides of the front end portion of a lower body 110; hinge support members 130 that have locking protrusions 131 protruding upward at both sides and a hinge groove 132 between the locking protrusions 131 to be fitted in the fitting grooves 120; locking steps 140 protruding upward and provided at both sides of the center portion of the lower body 110; a conveying groove 150 is provided at the center portion in the locking step 140; a spring-fixing protrusion 160 protruding upward and provided at the center portion on the bottom of the lower body 110; a first prevention film insertion groove 170 in which the lower portion of a backward flow prevention film 500 is inserted and which is formed along the inner surface of the front end portion of the lower body 110; a first up-down conveying-fixing step 180 protruding upward in a semicircular shape and provided behind the first prevention film insertion groove 170; and a lower fixing groove 190 formed in a semicircular shape on the inner surface of the rear end portion of the lower case 100 to insert the lower portion of the fixing ring 700.

The upper case 200 has: a support member insertion grooves 220 formed at both inner sides of the front end portion of an upper body 200 of a long semicircular shape to insert the locking protrusions 131 of the hinge support member 130 of the lower case 100; locking-step insertion grooves 230 provided at the lower portions of both inner sides at the center portion of the upper body 210 and connected to the upper portion of the lower case 100 to insert the locking steps 140 of the lower case 100; a semicircular second prevention film insertion groove 240 formed on the inner surface of the front end portion of the upper body 210 to insert the upper portion of the backward flow prevention film 500; a second up-down conveying-fixing step 250 protruding downward in a semicircular shape, behind the second prevention film insertion groove 240; and an upper fixing groove 260 formed in a semicircular shape on the inner surface of the rear end portion of the upper case 200 to insert the upper portion of the fixing ring 700.

Further, the weaving torch 300 has: a wire insertion hole 330 formed through the center portion of a torch body 310 to insert a welding wire 320; a welding tip 340 connected to the front end of the torch body 310; a welding cable 350 having a copper wire 353 between a gas cable 351 and an insulated cable 352 and connected to the rear end of the torch body 310 to supply outside power; hinge protrusions 360 protruding outside on both sides at the front portion of the torch body 310; hinge pins 370 protruding outside in a smaller size than the hinge protrusion 360 on the outer surface of the hinge protrusion 360 to be fitted in the hinge groove 132 of the hinge support member 130 of the lower case 100; conveying protrusions 380 protruding outside on both sides at the center portion of the torch body 310; conveying pins 390 provided on the outer surface of the conveying protrusions 380 to be fitted in the conveying grooves 150 of the lower case 100; and a hinge-fixing spring 610 of which the lower end is supported by the upper portion of the torch body 310 and the upper portion thereof is supported by the lower portion of upper body 210 of the upper case 200 to fix the hinge pin 370 such that the hinge pin 370 does not move upward. The electromagnet 400 has: a detachable conveying plate 420, which is attached/detached to the upper portion of an electromagnet body 410 and conveyed up/down by power that is supplied from the outside, at the upper portion of the electromagnet body 410; an electromagnetic shaft 430 connected to the central lower portion of the detachable conveying plate 420 and conveyed down with the detachable conveying plate 420 through the center of the electromagnet body 410 and the upper body 210 of the upper case 200; an insulating cap 440 connected to the lower end of the electromagnetic shaft 430 to insulate the electromagnet shaft 430 from the torch body 310 of the weaving torch 300; an up-down conveying-adjusting member 450 making it possible to adjust up-down conveying distance of the detachable conveying plate 420 and the electromagnetic shaft 430 while being conveyed up/down; and an electromagnet protection case 460 having a threaded-hole 470 at the upper center portion and in which the electromagnet body 410 of the electromagnet 400 is inserted such that the electromagnet body 410 is not exposed outside, and fixed to the upper portion of the upper body 210 of the upper case 200 by fixing-bolts 480 to discharge the heat, which generated from the electromagnet body 410 of the electromagnet 400, to the outside.

The support ring 800 has a flow channel 820 at the center portion of a ring body 810 and a plurality of support protrusions 830 protruding at regular intervals along the outer surface of the ring body 810, a plurality of lower movement prevention protrusions 191 protrude upward along the inner surface of the lower fixing groove 190 of the lower case 100 to fix the lower portion of the fixing ring 700 by contacting with the lower outer surface of the fixing ring 700, and a plurality of upper movement prevention protrusions 261 is formed to protrude at regular intervals along the inner surface of the upper fixing groove 260 of the upper case 200 to fix the upper portion of the fixing ring 700 by contacting with the outer surface of the upper portion of the fixing ring 700.

### Advantageous Effects

According to the weaving torch apparatus for auto welding having the above configuration of the present invention, it is possible to maintain necessary molten metal for desired welding such as welding by a person and provide the best welding beads, by locking a hinge pin and a conveying pin, which are provided to both sides of a weaving torch of a torch device connected to a welding machine, to a locking protrusion and a locking step of a hinge support member of a lower case in order to prevent left/right conveying while the weaving torch of the torch device connected to a welding machine automatically weaves while the conveying pins provided behind the hinge pins are reciprocated up/down with respect to the hinge pins by the operation of the electromagnet and the conveying spring.

Further, according to an aspect of the invention, since it is possible to prevent internal defects of the weaving torch by preventing backward flow of spatters, smoke, flame etc., which are created during welding, into the lower case and the upper case, and also to extend the life span of an electromagnet and increase the welding speed to the maximum while increasing work efficiency and productivity, by using a backward flow prevention film that is provided in a welding tip connected to the front end of a torch body of a weaving torch and of which the lower portion and the upper portion are disposed in the front end portion of a lower case and an upper case.

Further, according to another aspect of the invention, it is possible to maintain desired quality of welding beads and welding by automatically weaving the weaving torch using the electromagnet and a conveying spring, and can considerably decrease the amount of spatters and improve the work conditions and safety during welding.

Further, according to another aspect of the invention, it is possible to fix a welding cable to provide the best quality welding beads by preventing influence on the welding quality due to changes in up-down weaving width of the torch when the welding cable connected to the rear end of the weaving torch is moved by external shock.

Further, according to another aspect of the present invention, it is possible to easily supply a welding wire and carbon dioxide into a gas cable by press-fitting a fixing ring, which is fixed on the inner surfaces of the rear end portions of the lower case and the upper case, on the outer surface of an insulated cable of the welding cable, and providing a support ring that supports the fixing ring such that the gas cable is not compressed by the fixing ring press-fitted on the outer surface of the insulated cable.

Further, according to another aspect of the present invention, it is possible to prevent influence on weaving of the weaving torch, even if external pressure or external shock is applied to the welding cable, by forming fixing grooves, which fix the upper portion and the lower portion of the fixing ring that is press-fitted on the outer surface of the insulated cable of the welding cable, on the inner surfaces of the rear end portions of the lower case and the upper case, and providing a plurality of movement prevention protrusions on the inner surfaces of the fixing grooves to fix the fixing ring while closely contacting with the outer surface of the fixing ring.

### BRIEF DESCRIPTION OF DRAWINGS

FIG. 1 is an exemplary view showing a weaving torch device according to the present invention.

FIG. 2 is an exemplary view showing the inside of the weaving torch device according to the present invention.

FIG. 3 is an exemplary view showing the insides of a lower case and an upper case of the weaving torch device according to the present invention.

FIG. 4 is an exemplary view showing an electromagnet protection case separated from the upper case in the weaving torch device according to the present invention.

FIG. 5 is an exemplary view showing separate upper case and lower case of the weaving torch device according to the present invention.

FIG. 6 is an exemplary view showing a weaving torch combined with the lower case and the upper case in the weaving torch device according to the present invention.

*FIG. 7 is an exemplary view showing a support ring of the weaving torch device according to the present invention.

FIG. 8 is an exemplary view showing the weaving torch separated from the lower case of the weaving torch device according to the present invention.

FIG. 9 is an exemplary view showing the inside of the weaving torch of the weaving torch device according to the present invention.

FIG. 10 is an exemplary view illustrating the operation of the weaving torch in the lower case and the upper case of the weaving torch device according to the present invention.

FIG. 11 is an exemplary view illustrating an operational step of the weaving torch of the weaving torch device according to the present invention.

FIG. 12 is an exemplary view illustrating the operation of the weaving torch of the weaving torch device according to the present invention.

FIG. 13 is an exemplary view showing another embodiment of the lower case and the upper case of the weaving torch device according to the present invention.

FIG. 14 is an exemplary view showing another embodiment of the lower case and the upper case of the weaving torch device according to the present invention.

FIG. 15 is an exemplary view showing another embodiment of the lower case and the upper case of the weaving torch device according to the present invention.

FIG. 16 is an exemplary view showing another embodiment of the lower case and the upper case of the weaving torch device according to the present invention.

### BEST MODE FOR CARRYING OUT THE INVENTION

Preferred embodiments of the invention are described hereafter in detail with reference to the accompanying drawings.

Respective reference numerals 900 and 910 in the drawings designate a welding nozzle that is connected to the front end portions of an upper case and a lower case, and a case-fixing cap that is thread-fastened to the lower ends of the lower case and the upper case to fix the lower case and the upper case.

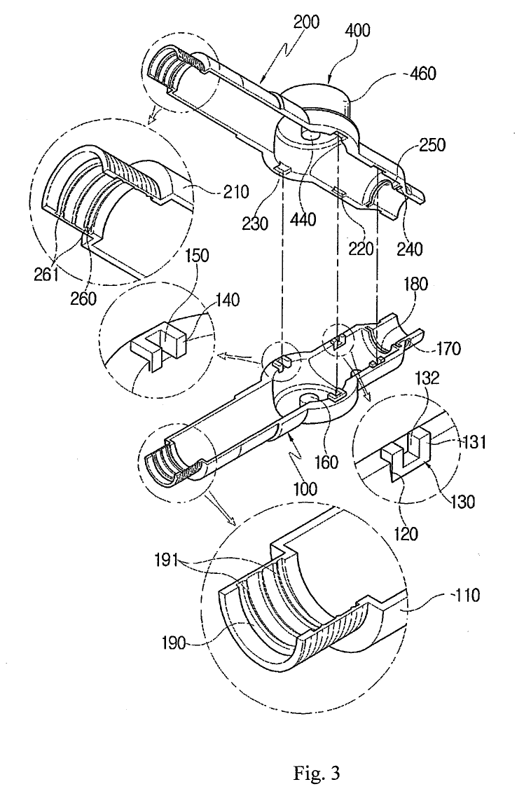

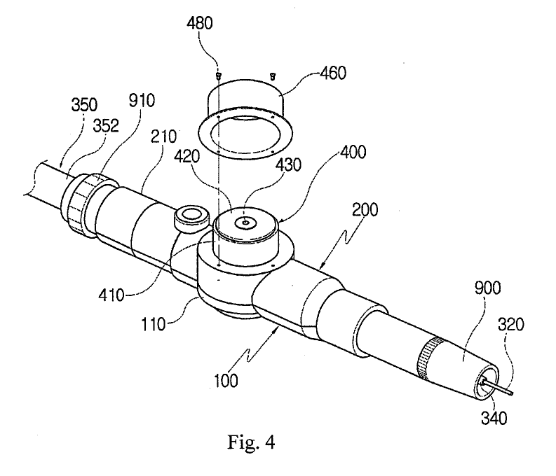

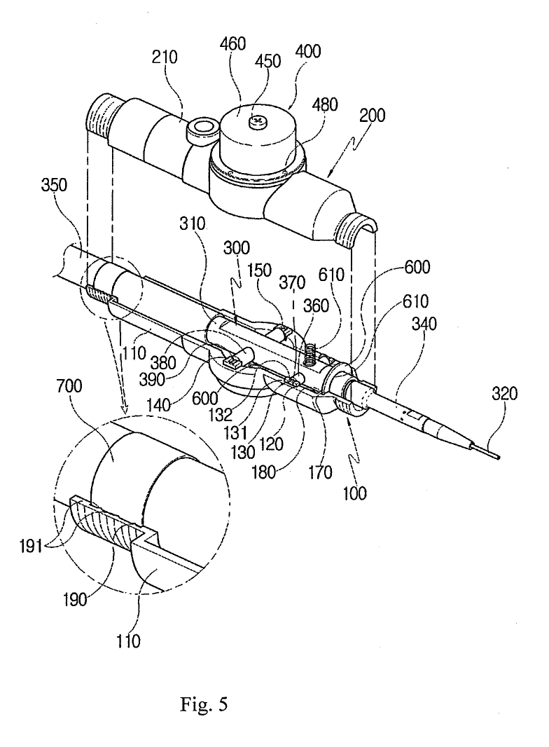

First, as for the lower case 100 of the present invention, as shown in FIG. 3, a fitting groove 120 is formed at both inner sides of the front end portion of a lower body 110 formed in a long semicircular shape, a hinge support member 130 having a locking protrusion 131 protruding upward at both sides and a hinge groove 132 between the locking protrusions 131 to be fitted in the fitting groove 120 is provided, a locking step 140 protruding upward is provided at both sides of the center portion of the lower body 110, a conveying groove 150 is provided at the center portion in the locking step 140, and a spring-fixing protrusion 160 protruding upward is provided at the center portion on the bottom of the lower body 110.

Further, a semicircular first prevention film insertion groove 170 where the lower portion of a backward flow prevention film 600 is inserted is formed along the inner surface of the front end portion of the lower body 110, and a first up-down conveying-fixing step 180 protruding upward in a semicircular shape is provided behind the first prevention film insertion groove 170.

On the other hand, as for the upper case 200, a support member insertion groove 220 where the locking protrusion 131 of the hinge support member 130 of the lower case 100 is inserted is formed at both inner sides of the front end portion of an upper body 210 formed in a long semicircular shape, and a locking-step insertion groove 230 where the locking step 140 of the lower case 100 is inserted is provided at the lower portions of both inner sides at the center portion of the upper body 210 and connected to the upper portion of the lower case 100.

Further, a semicircular second prevention film insertion groove 240 where the upper portion of the backward flow prevention film 500 is inserted is formed at the position corresponding to the first prevention insertion groove 170 of the lower case 100, along the inner surface of the front end portion of the upper body 210 of the upper case 200, and a second up-down conveying-fixing step 250 protruding downward in a semicircular shape is provided behind the second prevention film insertion groove 240.

A lower fixing groove 190 is formed, as shown in FIG. 3, along the inner surface of the rear end portion of the lower case 100 to insert the lower portion of the fixing ring 700, and a plurality of lower movement prevention protrusions 191 protrude upward along the inner surface of the lower fixing groove 190 to fix the lower portion of the fixing ring 700 by contacting with the lower outer surface of the fixing ring 700.

An upper fixing groove 260 where the upper portion of the fixing ring 700 is inserted and fixed is formed at the position corresponding to the lower fixing groove 190, along the inner surface of the rear end portion of the upper case 200, and a plurality of upper movement prevention protrusions 261 is formed to protrude at regular intervals along the inner surface of the upper fixing groove 260 of the upper case 200 to fix the upper portion of the fixing ring 700 by contacting with the outer surface of the upper portion of the fixing ring 700.

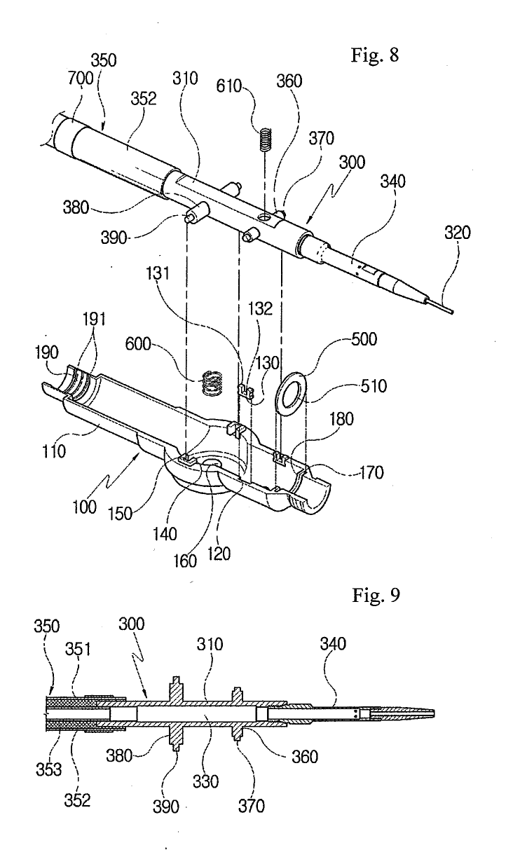

On the other hand, as for the weaving torch 300, as shown in FIGS. 8 and 9, a wire insertion hole 330 is formed through the center portion of a torch body 310 to insert a welding wire 320, a welding tip 340 is connected to the front end of the torch body 310, a welding cable 350 where outside power is supplied is connected to the rear end of the torch body 310, and a hinge protrusion 360 protruding outside is formed on both sides at the front portion of the torch body 310.

A hinge pin 370 that protrudes outside in a smaller size than the hinge protrusion 360 and is fitted in the hinge groove 132 of the hinge support member 130 of the lower case 100 is provided on the outer surface of the hinge protrusion 360.

Further, a conveying protrusion 380 protruding outside is provided on both sides at the center portion of the torch body 310 and a conveying pin 390 that is fitted in the conveying groove 150 of the lower case 100 is provided on the outer surface of the conveying protrusion 380 and fitted in the lower case 100 and the upper case 200.

The sides of the hinge protrusions 360 protruding outside from both sides of the front portion of the torch body 310 of the weaving torch 300 closely contact with the inner surface of the locking protrusions 131 when the hinge pins 370 are inserted into the hinge grooves 132 of the hinge support members 130 of the lower case 100. Further, the sides of the conveying protrusions 380 protruding outside from both sides of the center portion of the torch body 310 closely contact with the inner surface of the locking steps 140 when the conveying pins 390 are inserted into the conveying grooves 150 of the lower case 100, such that the torch body 310 of the weaving torch 300 is prevented from being conveyed to the left and right when being conveyed up and down.

A hinge-fixing spring 800 is disposed between the upper portion of the torch body 310 of the weaving torch 300 and the lower portion of the upper body of the upper case, with the lower end supported by the upper portion of the torch body 310 and the upper portion supported by the lower portion of the upper body 210 of the upper case 200 in order to allow the torch body 310 of the weaving torch 300 to be stably conveyed up and down with respect to the hinge pin 370 even if external shock is applied, while fixing and preventing the hinge pin 370 from moving upward and separating from the hinge groove 132 of the hinge support member 130.

It is preferable to make the hinge support member 130 of the lower case 100 from a metal to prevent wear due to friction with the hinge pin 370 of the weaving torch 300.

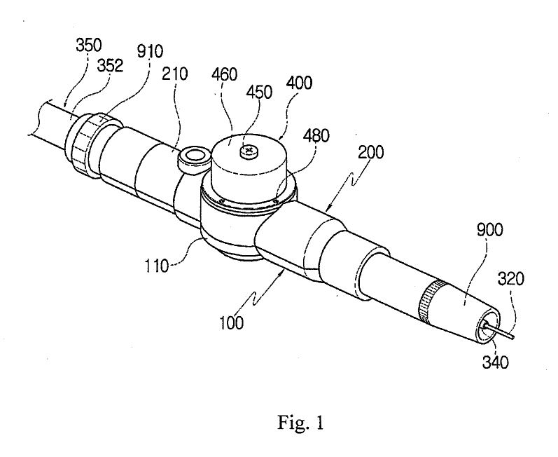

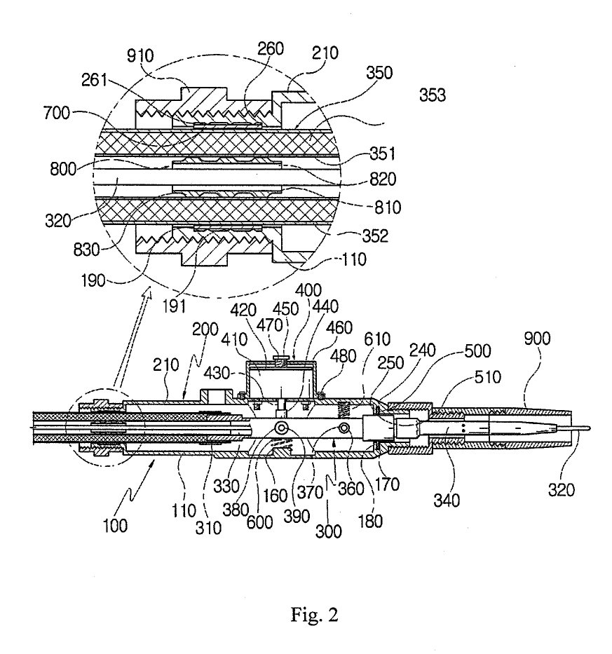

Meanwhile, as shown in FIGS. 1 and 2, the welding cable 350 having a copper wire 353 between a gas cable 351 and an insulated cable 352 is connected to the rear end of the weaving torch 300.

The fixing ring 700 is fixed on the outer surface of the insulated cable 352 of the welding cable 350 and it is preferable to press-fit the fixing ring 700 firmly at an appropriate position on the outer surface of the insulated cable 352 by a device, such as a hydraulic press such that it is inserted in the lower fixing groove 190 and the upper fixing groove 260 formed on the inner surfaces at the rear end portions of the lower case 100 and the upper case 200.

A support ring 800 is inserted in the gas cable 351 of the welding cable 350 to be positioned at the center portion in the fixing ring 700 and supports fixing ring 700 press-fitted on the outer surface of the insulated cable 352 in the gas cable 351.

The support ring 800, as shown in FIG. 7, is provided with a flow channel 820 at the center portion of a ring body 810 and a plurality of support protrusions 830 is formed at regular intervals on the outer surface of the ring body 810.

It is preferable to round both edges of the support protrusion 830 of the support ring 800.

An electromagnet 400 that conveys down the torch body 310 of the weaving torch 300 is connected to the central upper portion of the upper body 210 of the upper case 200, in which the electromagnet 400, as shown in FIGS. 1, 2, and 6, is provided with a detachable conveying plate 410, which is attached/detached to the upper portion of an electromagnet body 410 and conveyed up/down by power that is supplied from the outside, at the upper portion of the electromagnet body 410, and an electromagnetic shaft 430 that is connected to the central lower portion of the detachable conveying plate 410 and conveyed down with the detachable conveying plate 420 through the center of the electromagnet body 410 and the upper body 210 of the upper case 200. In this configuration, an insulating cap 440 is connected to the lower end of the electromagnetic shaft 430 to insulate the electromagnet shaft 430 from the torch body 310 of the weaving torch 300 where electric current is transmitted through the welding cable 350 of the welding machine.

In the electromagnet 400, it is possible to adjust the up-down conveying distance of the detachable conveying plate 420 of the electromagnet 400 by rotating an up-down conveying-adjusting member 450 that is thread-fastened in a threaded-hole 470 formed at the central upper portion of the electromagnet protection case 460.

It is preferable to closely contact the electromagnet body 410 of the electromagnet 400 to the upper end portion of the upper body 210 of the upper case 200 and then firmly fix it to the lower portion of the upper body 210 with a fixing-bolt (not shown).

As shown in FIGS. 1 and 2, the electromagnet protection case 460 that protects the electromagnet 400 has a threaded-hole 470 at the upper center portion and in which the electromagnet body 410 of the electromagnet 400 is inserted such that the electromagnet body 410 is not exposed outside. Further, the electromagnet protection case 460 is fixed to the upper portion of the upper body 210 of the upper case 200 by fixing-bolts 480 to discharge the heat, which is generated from the electromagnet body 410 of the electromagnet 400, to the outside through the electromagnet protection case 460.

In this configuration, it is preferable to form a conveying space between the upper inner side of the electromagnet protection case 460 of the electromagnet 500 and the detachable conveying plate 420 of the electromagnet 400 such that the electromagnetic shaft 430 connected to the central lower portion of the detachable conveying plate 420 can be conveyed up/down.

The backward flow prevention film 500, as shown in FIG. 7, has a through-hole 510 at the center to be fitted on the welding tip 340 connected to the front end of the torch body 310 of the weaving torch 300, and of which the lower portion is inserted in the first prevention film insertion groove 170 formed on the inner surface at the front end portion of the lower body 110 of the lower case 100 and the upper portion is inserted in the second prevention film insertion groove 240 formed on the inner surface at the front end portion of the upper body 210 of the upper case 200 such that the inside of the lower body 110 of the lower case 100 and the inside of the upper body 210 of the upper case 200 is sealed from the outside.

The backward flow prevention film 500 is preferably made of a flexible material, such as silicon, which is high-temperature heat proof due to the generation of heat during welding and has good heat resistance and wears resistance, in order not to be worn in long-time use.

The lower portion of the conveying spring 600 that conveys upward the torch body 310, as shown in FIG. 8, is fitted on the spring-fixing protrusion 160 of the lower body 110 of the lower case 100 and the upper portion is disposed between the lower body 110 of the lower case 100 and the torch body 310 of the weaving torch 300 to support the lower portion of the torch body 310 of the weaving torch 300.

The welding nozzle 900 that protects the welding tip 310 connected to the front end of the torch body 310 of the weaving torch 300 is connected to the front ends of the lower body 110 of the lower case 100 and the upper body 210 of the upper case 200.

The ring body 810 of the support ring 800 is inserted in the gas cable 351 of the welding cable 350, in which it is easy to insert the support ring 800 into the gas cable 351 because the edges of the support protrusions 830 formed at regular intervals on the outer surface of the ring body 810 are rounded.

After the ring body 810 of the support ring 80 is inserted in the gas cable 351 of the welding cable 350 as described above, the fixing ring 700 is press-fitted on the outer surface of the insulated cable 352, corresponding to the position of the support ring 800, by a device, such as a hydraulic press.

In this operation, it is possible to prevent the inside of the gas cable 351 from bending or narrowing by pressing when the fixing ring 700 is press-fitted onto the outer surface of the insulated cable 352 of the welding cable 350 because the support protrusions 830 of the fixing ring 800 inserted in the gas cable 351 supports the fixing ring 700 in the gas cable 351.

Further, since the support ring 800 that supports the fixing ring 700 is inserted such that the inside of the gas cable 351 of the welding cable 350 is not compressed as described above, the welding wire 320 and carbon dioxide can be easily supplied into the gas cable 351 through the through-hole 820 of the ring body 810.

The front end of the welding cable 350 is connected to the rear end of the torch body 310 of the weaving torch 300 after the support ring 800 is inserted in the gas cable 351 of the welding cable 350 and the fixing ring 700 is fixed on the outer surface of the insulated cable 352.

In this configuration, the gas cable 351 of the welding cable 350 is inserted in the torch body 310 of the weaving torch 300 and the copper wire 353 provided between the gas cable 351 and the insulated cable 352 is connected with the torch body 310 while the insulated cable 352 wraps the outer surface of the torch body 310 of the weaving torch 100.

Further, it is preferable to firmly fix the welding cable 350 using a fixing ring, which is not shown in the drawings, similar to the fixing ring 700, in order that the welding cable 350 does not separate from the torch body 310.

The welding cable connected to the rear end of the torch body 310 of the weaving torch 300 as described above is inserted down from above the lower case 100 such that the lower portion of the fixing ring 700 fixed on the outer surface of the insulated cable 352 is inserted into the lower fixing groove 190 on the inner surface at the rear end portion of the lower case 100, as shown in FIG. 8.

According to this configuration, the lower portion of the fixing ring 700 is inserted in the lower fixing groove 190 and the lower movement prevention protrusions 191 protruding upward from the inner surface of the lower fixing groove 190 are in close contact with the lower outer surface of the fixing ring 700 and supports the lower portion of the fixing ring 700.

With the lower portion of the fixing ring 700 inserted in the lower fixing groove 190 of the lower case 100, the upper portion of the fixing ring 700 is inserted into the upper fixing groove 260 on the inner surface at the rear end portion of the upper case 200 by conveying down the upper case 200 from above the welding cable 350.

The upper movement prevention protrusions 261 on which the upper portion of the fixing ring 700 is fitted and which protrude downward from the inner surface of the upper fixing groove 260 as described above are in close contact to the upper outer surface of the fixing ring 700 and support the upper portion of the fixing ring 700.

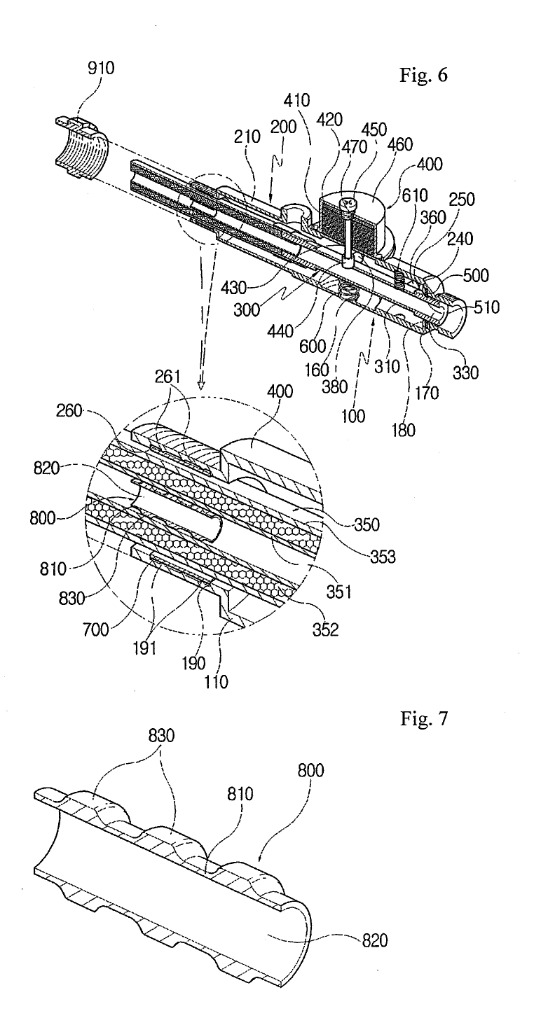

After the lower case 100 and the upper case 200 are combined such that the lower portion and the upper portion of the fixing ring 700 are inserted in the lower fixing groove 190 and the upper fixing groove 260 of the lower case 100 and the upper case 200, respectively, as shown in FIG. 6, a fixing cap 910 with a thread on the inner surface is thread-fastened to the rear end portions of the lower case 100 and the upper case 200 such that the lower body 110 and the upper body 210 of the lower case 100 and the upper case 200 is fixed such that they are not separated.

The fixing ring 700 with the lower portion and the upper portion inserted in the lower fixing groove 190 and the upper fixing groove 260 is kept fixed on the inner surface of the rear end portions of the lower case 100 and the upper case 200 without moving up/down and left/right.

### Mode for the Invention

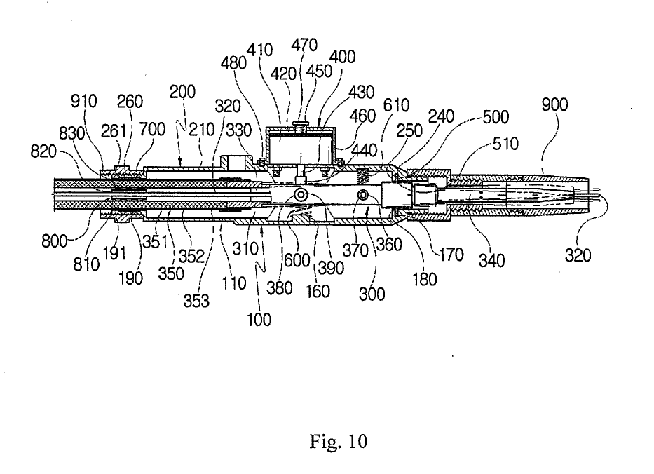

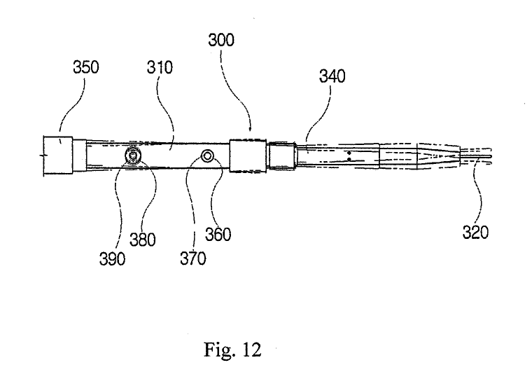

According to the weaving torch device assembled as described above, as shown in FIGS. 10 to 12, with the welding wire 320 inserted in the wire insertion hoe 330 formed in the torch body 310 of the weaving torch 300, when the welding machine (not shown) is started, the welding wire 320 is continuously supplied through the flow channel 820 formed through the center of the ring body 810 of the support ring 800 in which the gas cable 351 of the welding cable 350 connected with the welding machine and carbon dioxide is simultaneously supplied. Further, electric current is supplied to the torch body 310 of the weaving torch 100 through the copper wire 353 disposed between the gas cable 351 and the insulated cable 352 and the electric current that is conducted through the torch body 310 is transmitted through the torch body 310 to the welding tip 340 connected to the front end of the torch body 310, and as a result, a welding process is started.

A magnetic field is created in the electromagnet body 410 of the electromagnet 400 by applying power to the electromagnet 400 through an outside power controller (not shown) before the welding process is started, and the detachable conveying plate 420 disposed at the upper portion of the electromagnet body 410 contacts with the upper end of the electromagnet body 410 by the magnetic field.

The power controller that applies power to the electromagnet body 410 of the electromagnet 400 as described above turns on/off at regular time intervals.

As the power is applied to the electromagnet body 410 of the electromagnet 400 and the detachable conveying plate 420 is in contact with the upper end of the electromagnet body 410 disposed under a detachable conveying plate 420 as described above, the electromagnetic shaft 430 connected to the central lower portion of the detachable conveying plate 420 is conveyed down and the lower end of the electromagnetic shaft 430 pushes down the torch body 310 of the weaving torch 300.

As the lower end of the electromagnetic shaft 430 pushes down the torch body 310 of the weaving torch 300 as described above, the conveying spring 600 that is fitted on the spring-fixing protrusion 160 protruding upward from the center of the lower body 110 of the lower case 100 and of which the lower portion is supported by the upper end of the lower body 110 of the lower case 100 and the upper portion is supported by the lower portion of the torch body 310 is compressed and the torch body 310 rotates about the hinge pin 370 fitted in the hinge groove 132 of the hinge support member 130 of the lower case 100, such that the conveying pins 390 protruding from the outer surfaces of the conveying protrusions 380 protruding outside from both sides of the center portion of the torch body 310 is conveyed down through the conveying grooves 150 formed in the inner surface of both sides of the lower body 110 of the lower case 100.

The insulating cap 440 connected to the lower end of the electromagnetic shaft 430 insulates the electromagnetic shaft 430 by blocking the electric current that is transmitted through the welding cable 350 with one end connected to the welding machine and the other end connected to the rear end of the torch body 310.

As the torch body 310 of the weaving torch 300 is conveyed down from the hinge pin 370 as described above, the welding tip 340 connected to the front end of the torch body 310 of the weaving torch 300 is conveyed upward.

Further, as the welding tip 340 connected to the front end of the torch body 310 of the weaving torch 300 is conveyed upward by the electromagnet shaft 430 of the electromagnet 400 conveyed down and the power controller (not shown) that applies power to the electromagnet 400 turns off, the torch body 310 is conveyed upward by elasticity of the conveying spring 600 supported by the lower portion of the torch body 310, with the magnetic force of the electromagnet body 410 removed.

As the torch body 310 of the weaving torch 300 is conveyed upward by the conveying spring 600, the electromagnetic shaft 430 that is in close contact to the torch body 310 is correspondingly conveyed upward, such that the detachable conveying plate 420 contacting with the upper end of the electromagnet body 410 is separated from the upper end of the electromagnet body 410 and conveyed upward.

Further, as the torch body 310 is conveyed upward as described above, the welding tip 340 connected to the front end of the torch body 310 is conveyed downward from the hinge pin 370.

The welding wire 320 is welded and welding beads are formed while the torch body 310 of the weaving torch 300 is automatically reciprocated up/down, that is, woven by the conveying spring 600 that conveys up/down the torch body 310 and the electromagnetic shaft 430 that conveys down the torch body 310 while being turned on/off by the power controller that applied power to the electromagnet 400.

By rotating, in one direction, the up-down conveying-adjusting member 450 that is thread-fastened in the threaded-hole 470 formed at the central upper portion of the electromagnet protection case 460 of the electromagnet 400, the lower end of the up-down conveying-adjusting member 450 is conveyed down and the up-down conveying distance of the detachable conveying plate 420 of the electromagnet 400 is adjusted while the distance between the detachable conveying plate 420 and the up-down conveying-adjusting member 450 decreases, such that the up-down conveying distance of the electromagnetic shaft 430 that is conveyed up/down with the detachable conveying plate 420 is adjusted. As a result, the weaving distance of the weaving torch 300 can be maintained at a predetermined value by adjusting the up-down conveying distance of the electromagnetic shaft 430 at a predetermined value.

It is possible to prevent influence on the welding quality due to change in up-down weaving width of the weaving torch 100 and provides a welding bead of the best quality, even if external shock or pressure is applied to the welding cable 350, because the welding cable 350, which is press-fitted on the outer surface of the insulated cable 352 and of which the lower portion and the upper portion are inserted in the lower fixing groove 190 and the upper fixing groove 260 of the lower case 100 and the upper case 200, respectively, is not moved by the fixing ring 700 of which the lower outer surface and the upper surface are supported by the lower movement prevention protrusions 191 formed on the inner surface of the lower fixing groove 190 and the upper movement prevention protrusions 261 formed on the inner surface of the upper fixing groove 260.

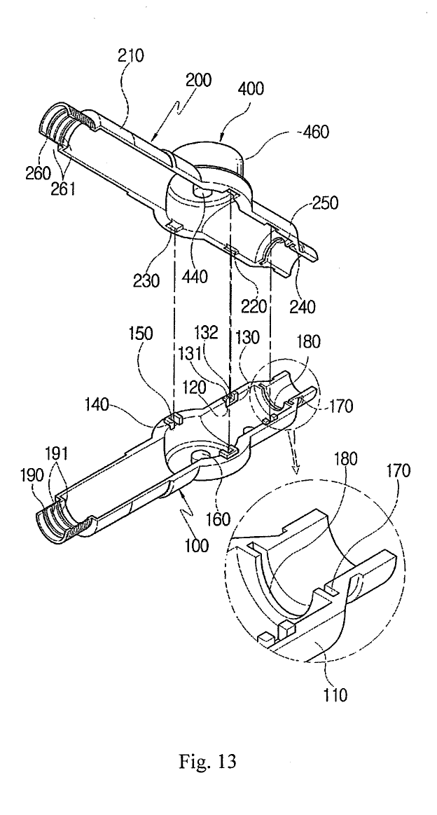

On the other hand, FIG. 13 is an exemplary view showing another embodiment of the lower case and the upper case of the weaving torch device according to the present invention. According to this embodiment, a first up-down conveying-fixing step 180 and a second up-down conveying-fixing step 250 that protrude up and down from the inner surfaces of the lower body 110 of the lower case 100 and the upper body 210 of the upper case 200, respectively, have elliptical inner surfaces that are long in the up-down direction, such that the welding tip 340 connected to the front end of the torch body 310 of the weaving torch 300 can be conveyed only up/down between the first up-down conveying-fixing step 180 and the second up-down conveying-fixing step 250, but cannot be conveyed left/right.

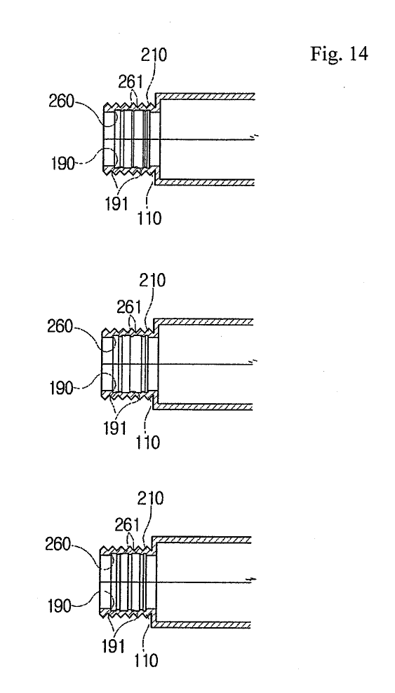

Further, FIG. 14 is an exemplary view showing another embodiment of the lower case and the upper case of the weaving torch device according to the present invention. According to this embodiment, it is possible to form the lower movement prevention protrusion 191 and the upper movement prevention protrusion 261 of the lower case 100 and the upper case 200 in various shapes, which can fix the lower and upper outer surfaces of the fixing ring 700 fitted on the outer surface of the insulated cable 352 of the welding cable 350 while contacting with the lower and the upper surfaces, on the inner surface of the rear end portions of the lower case 100 and the upper case 200, such as triangle, semicircle, ellipse, or rectangle.

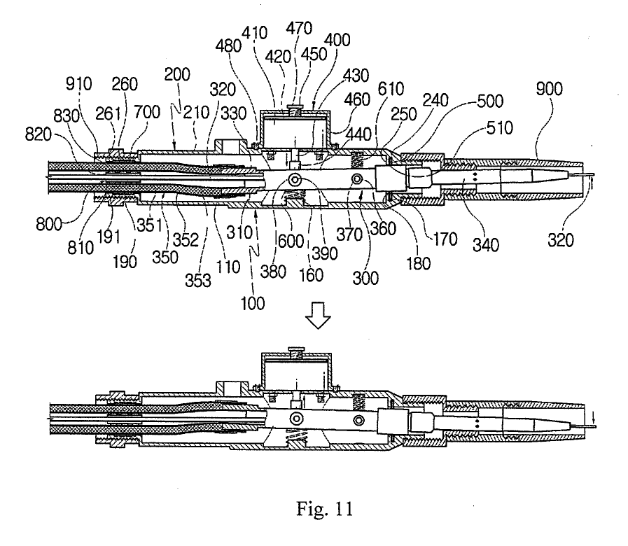

On the other hand, as shown in FIGS. 10 and 11, the backward flow prevention film 500, which is fitted on the welding tip 340 connected to the front end of the torch body 310 of the weaving torch 300 by the through-hole 510 formed at the center, of which the lower portion is inserted in the first prevention film insertion groove 170 formed on the inner surface at the front end portion of the lower body 110 of the lower case 100 and the upper portion is inserted in the second prevention film insertion groove 240 formed on the inner surface at the front end portion of the upper body 210 of the upper case 200 to seal the inside of the lower body 110 of the lower case 100 and the inside of the upper body 210 of the upper case 200 from the outside, prevents backward flow of spatters, smoke, and flame etc., which are created during welding, into the lower case and the upper case. Therefore, it is possible to prevent internal defects of the weaving torch and extend the life of the electromagnet.

Meanwhile, the weaving torch 300 can prevent the torch body 310 from being conveyed left/right while the torch body 310 is conveyed up/down, because the outer surface of the hinge protrusions 360 protruding from both sides of the front portion of the torch body 310 closely contact with the inner surfaces of the locking protrusions of the hinge support members 130 when the hinge pins 370 are inserted in to the hinge grooves 132 of the hinge support members 130, the sides of the conveying protrusions 380 protruding outside from both central sides of the torch body 310 close contact with the locking steps 140 when the conveying pins 390 are inserted into the conveying grooves 150 of the lower case 100, and the first up-down conveying-fixing step 180 of the lower case 100 and the second up-down conveying-fixing step 250 of the upper case 200 support both sides of each of the hinge protrusion 360, the conveying protrusion 380, and the welding tip 340 of the weaving torch 300.

According to the weaving torch device according to the present invention, it is possible to achieve welding speed of 1300 mm/min, such that productivity can be considerably improved.

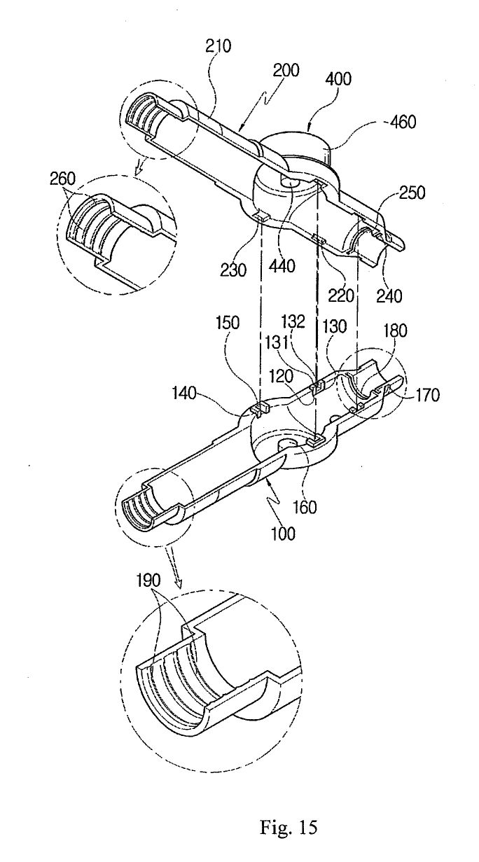

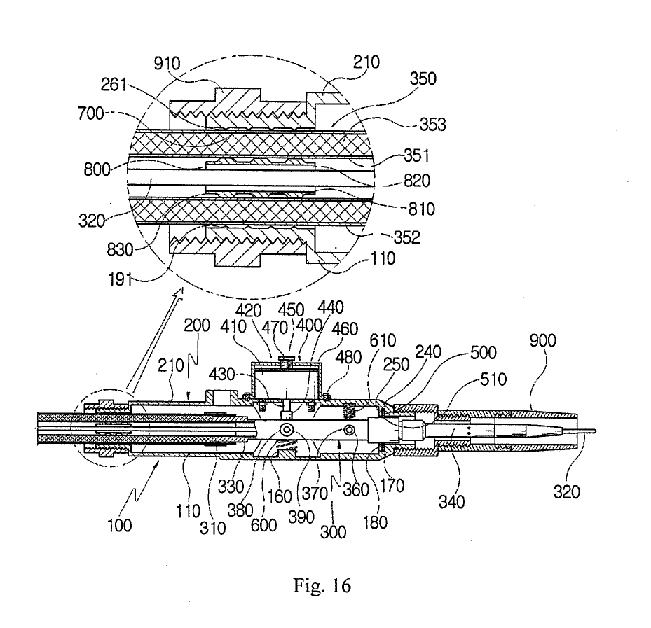

On the other hand, FIGS. 15 and 16 are exemplary views showing another embodiment of the lower case and the upper case of the weaving torch device according to the present invention. According to this embodiment, the lower movement prevention protrusions 191 and the upper movement prevention protrusions 261 protrude from the inner surfaces at the rear end portions of the lower body 110 of the lower case 100 and the upper body 210 of the upper case 200, such that it is possible to prevent the welding cable 350 from moving by closely contacting the lower movement prevention protrusions 191 and the upper movement prevention protrusions 261 to the outer surface of the insulated cable 352 when the fixing ring 700 is not provided to the insulated cable 352 of the welding cable 350.

1. A weaving torch apparatus for auto welding, comprising:
a lower case 100 that has a lower body 110 formed in a long semicircular shape;
an upper case 200 that has an upper body 210 formed in long semicircular shape and is connected to the upper portion of the lower case 100;
a weaving torch 300 that has a torch body 310 having a wire insertion hole 330 at the center portion, where a welding wire 320 is inserted, and is disposed inside the lower case 100 and the upper case 200 while transmitting welding electric current of a welding machine to a welding tip 340, in which a welding tip 340 is connected to the front end of the torch body 310, a welding cable 350 through which outside power is supplied is connected to the rear end of the torch body 310;
an electromagnet 400 that is connected to the upper center portion of the upper body 210 of the upper case 200 and conveys the torch body 310 of the weaving torch 300 downward;
a backward flow prevention film 500 that has a through-hole at the center and is disposed at the front end portions inside the lower body 110 of the lower case 100 and the upper body 210 of the upper case 200 while being connected to the welding tip 340 connected to the front end of the torch body 310 of the weaving torch 300; and
a conveying spring 600 that conveys the torch body 310 upward using elasticity while the lower portion thereof is supported by the upper portion of the lower body 110 of the lower case 100 and the upper portion supports the lower portion of the torch body 310 of the weaving torch 300.

2. The weaving torch apparatus for auto welding according to claim 1, wherein the lower case 100 has:
fitting grooves 120 that are formed at both inner sides of the front end portion of a lower body 110;
hinge support members 130 that have locking protrusions 131 protruding upward at both sides and a hinge groove 132 between the locking protrusions 131 to be fitted in the fitting grooves 120;
locking steps 140 protruding upward and provided at both sides of the center portion of the lower body 110; a conveying groove 150 is provided at the center portion in the locking step 140;
a spring-fixing protrusion 160 protruding upward and provided at the center portion on the bottom of the lower body 110;
a first prevention film insertion groove 170 in which the lower portion of a backward flow prevention film 500 is inserted and which is formed along the inner surface of the front end portion of the lower body 110; and
a first up-down conveying-fixing step 180 protruding upward in a semicircular shape and provided behind the first prevention film insertion groove 170.

3. The weaving torch apparatus for auto welding according to claim 1, wherein the upper case 200 has:
a support member insertion grooves 220 formed at both inner sides of the front end portion of an upper body having a long semicircular shape to insert the locking protrusions 131 of the hinge support member 130 of the lower case 100;
locking-step insertion grooves 230 provided at the lower portions of both inner sides at the center portion of the upper body 210 and connected to the upper portion of the lower case 100 to insert the locking steps 140 of the lower case 100;
a semicircular second prevention film insertion groove 240 formed on the inner surface of the front end portion of the upper body 210 to insert the upper portion of the backward flow prevention film 500; and
a second up-down conveying-fixing step 250 protruding downward in a semicircular shape, behind the second prevention film insertion groove 240.

4. The weaving torch apparatus for auto welding according to claim 1, wherein the weaving torch 300 has:
a wire insertion hole 330 formed through the center portion of a torch body 310 to insert a welding wire 320;
a welding tip 340 connected to the front end of the torch body 310;
a welding cable 350 provided with a copper wire 353 between a gas cable 351 and an insulated cable 352 and connected to the rear end of the torch body 310 to supply outside power;
hinge protrusions 360 protruding outside on both sides at the front portion of the torch body 310;
hinge pins 370 protruding outside in a smaller size than the hinge protrusion 360 on the outer surface of the hinge protrusion 360 to be fitted in the hinge groove 132 of the hinge support member 130 of the lower case 100;
conveying protrusions 380 protruding outside on both sides at the center portion of the torch body 310;
conveying pins 390 provided on the outer surface of the conveying protrusions 380 to be fitted in the conveying grooves 150 of the lower case 100; and
a hinge-fixing spring 610 of which the lower end is supported by the upper portion of the torch body 310 and the upper portion thereof is supported by the lower portion of upper body 210 of the upper case 200 to fix the hinge pin 370 such that the hinge pin 370 does not move upward.

5. The weaving torch apparatus for auto welding according to claim 1, wherein the electromagnet 400 has:
a detachable conveying plate 420, which is attached/detached to the upper portion of an electromagnet body 410 and conveyed up/down by power that is supplied from the outside, at the upper portion of the electromagnet body 410;
an electromagnetic shaft 430 connected to the central lower portion of the detachable conveying plate 420 and conveyed down with the detachable conveying plate 420 through the center of the electromagnet body 410 and the upper body 210 of the upper case 200;
an insulating cap 440 connected to the lower end of the electromagnetic shaft 430 to insulate the electromagnet shaft 430 from the torch body 310 of the weaving torch 300;
an up-down conveying-adjusting member 450 making it possible to adjust up-down conveying distance of the detachable conveying plate 420 and the electromagnetic shaft 430 while being conveyed up/down; and
an electromagnet protection case 460 having a threaded-hole at the upper center portion and in which the electromagnet body 410 of the electromagnet 400 is inserted such that the electromagnet body 410 is not exposed outside, and fixed to the upper portion of the upper body 210 of the upper case 200 by fixing-bolts 480 to discharge the heat, which is generated from the electromagnet body 410 of the electromagnet 400, to the outside.

6. A weaving torch apparatus for auto welding, comprising:
a lower case 100 that has a lower body 110 formed in a long semicircular shape;
an upper case 200 that has an upper body 210 formed in long semicircular shape and is connected to the upper portion of the lower case 100;
a weaving torch 300 that has a torch body 310 having a wire insertion hole 330 at the center portion, where a welding wire 320 is inserted, and is disposed inside the lower case 100 and the upper case 200 while transmitting welding electric current from a welding machine to a welding tip 340, in which a welding tip 340 is connected to the front end of the torch body 310, a welding cable 350 through which outside power is supplied is connected to the rear end of the torch body 310;
an electromagnet 400 that is connected to the upper center portion of the upper body 210 of the upper case 200 and conveys downward the torch body 310 of the weaving torch 300;
a backward flow prevention film 500 that has a through-hole at the center and is disposed at the front end portions inside the lower body 110 of the lower case 100 and the upper body 210 of the upper case 200 while being connected to the welding tip 340 connected to the front end of the torch body 310 of the weaving torch 300;
a conveying spring 600 that conveys upward the torch body 310 using elasticity while the lower portion thereof is supported by the upper portion of the lower body 110 of the lower case 100 and the upper portion supports the lower portion of the torch body 310 of the weaving torch 300;
s fixing ring 700 fitted on the outer surface of an insulated cable 220 of the welding cable 200; and
a support ring 800 supporting the fixing ring 700 in a gas cable 210 of the welding cable 200.

7. The weaving torch apparatus for auto welding according to claim 6, wherein the lower case 100 has:
fitting grooves 120 that are formed at both inner sides of the front end portion of a lower body 110;
hinge support members 130 that have locking protrusions 131 protruding upward at both sides and a hinge groove 132 between the locking protrusions 131 to be fitted in the fitting grooves 120;
locking steps 140 protruding upward and provided at both sides of the center portion of the lower body 110; a conveying groove 150 is provided at the center portion in the locking step 140;
a spring-fixing protrusion 160 protruding upward and provided at the center portion on the bottom of the lower body 110;
a first prevention film insertion groove 170 in which the lower portion of a backward flow prevention film 500 is inserted and which is formed along the inner surface of the front end portion of the lower body 110;
a first up-down conveying-fixing step 180 protruding upward in a semicircular shape and provided behind the first prevention film insertion groove 170; and
a lower fixing groove 190 formed in a semicircular shape on the inner surface of the rear end portion of the lower case 100 to insert the lower portion of the fixing ring 700.

8. The weaving torch apparatus for auto welding according to claim 6, wherein the upper case 200 has:
a support member insertion grooves 220 formed at both inner sides of the front end portion of an upper body 200 of a long semicircular shape to insert the locking protrusions 131 of the hinge support member 130 of the lower case 100;
locking-step insertion grooves 230 provided at the lower portions of both inner sides at the center portion of the upper body 210 and connected to the upper portion of the lower case 100 to insert the locking steps 140 of the lower case 100;
a semicircular second prevention film insertion groove 240 formed on the inner surface of the front end portion of the upper body 210 to insert the upper portion of the backward flow prevention film 500;
a second up-down conveying-fixing step 250 protruding downward in a semicircular shape, behind the second prevention film insertion groove 240;
and an upper fixing groove 260 formed in a semicircular shape on the inner surface of the rear end portion of the upper case 200 to insert the upper portion of the fixing ring 700.

9. The weaving torch apparatus for auto welding according to claim 6, wherein the weaving torch 300 has:
a wire insertion hole 330 formed through the center portion of a torch body 310 to insert a welding wire 320;
a welding tip 340 connected to the front end of the torch body 310;
a welding cable 350 having a copper wire 353 between a gas cable 351 and an insulated cable 352 and connected to the rear end of the torch body 310 to supply outside power;
hinge protrusions 360 protruding outside on both sides at the front portion of the torch body 310;
hinge pins 370 protruding outside in a smaller size than the hinge protrusion 360 on the outer surface of the hinge protrusion 360 to be fitted in the hinge groove 132 of the hinge support member 130 of the lower case 100;
conveying protrusions 380 protruding outside on both sides at the center portion of the torch body 310;
conveying pins 390 provided on the outer surface of the conveying protrusions 380 to be fitted in the conveying grooves 150 of the lower case 100; and
a hinge-fixing spring 610 of which the lower end is supported by the upper portion of the torch body 310 and the upper portion thereof is supported by the lower portion of upper body 210 of the upper case 200 to fix the hinge pin 370 such that the hinge pin 370 does not move upward.

10. The weaving torch apparatus for auto welding according to claim 6, wherein the electromagnet 400 has:
a detachable conveying plate 420, which is attached/detached to the upper portion of an electromagnet body 410 and conveyed up/down by power that is supplied from the outside, at the upper portion of the electromagnet body 410;
an electromagnetic shaft 430 connected to the central lower portion of the detachable conveying plate 420 and conveyed down with the detachable conveying plate 420 through the center of the electromagnet body 410 and the upper body 210 of the upper case 200;
an insulating cap 440 connected to the lower end of the electromagnetic shaft 430 to insulate the electromagnet shaft 430 from the torch body 310 of the weaving torch 300;
an up-down conveying-adjusting member 450 making it possible to adjust up-down conveying distance of the detachable conveying plate 420 and the electromagnetic shaft 430 while being conveyed up/down; and
an electromagnet protection case 460 having a threaded-hole 470 at the upper center portion and in which the electromagnet body 410 of the electromagnet 400 is inserted such that the electromagnet body 410 is not exposed outside, and fixed to the upper portion of the upper body 210 of the upper case 200 by fixing-bolts 480 to discharge the heat, which generated from the electromagnet body 410 of the electromagnet 400, to the outside.

11. The weaving torch apparatus for auto welding according to claim 6, wherein the support ring 800 has a flow channel 820 at the center portion of a ring body 810 and a plurality of support protrusions 830 protruding at regular intervals along the outer surface of the ring body 810.

12. The weaving torch apparatus for auto welding according to claim 7, wherein the hinge support member 130 of the lower case 100 is made of metal.

13. The weaving torch apparatus for auto welding according to claim 7, wherein a plurality of lower movement prevention protrusions 191 protrude upward along the inner surface of the lower fixing groove 190 of the lower case 100 to fix the lower portion of the fixing ring 700 by contacting with the lower outer surface of the fixing ring 700.

14. The weaving torch apparatus for auto welding according to claim 8, wherein a plurality of upper movement prevention protrusions 261 is formed to protrude at regular intervals along the inner surface of the upper fixing groove 260 of the upper case 200 to fix the upper portion of the fixing ring 700 by contacting with the outer surface of the upper portion of the fixing ring 700.

15. The weaving torch apparatus for auto welding according to claim 13 or 14, wherein the shape of the lower movement prevention protrusion 191 and the upper movement prevention protrusion 261 of the lower case 100 and the upper case 200 is any one of triangle, semicircle, and rectangle.
